(19) United States
(12) Patent Application Publication
(10) Pub. No.: US 2019/0333475 A1
(43) Pub. Date: Oct. 31, 2019

(54) DISPLAY METHOD AND ELECTRONIC DEVICE

(71) Applicant: SHENZHEN ROYOLE TECHNOLOGIES CO., LTD., Shenzhen (CN)

(72) Inventors: Chao HAN, Shenzhen (CN); Yang FU, Shenzhen (CN)

(21) Appl. No.: 16/473,451

(22) PCT Filed: Dec. 26, 2016
(86) PCT No.: PCT/CN2016/112105

§ 371 Date: Jun. 25, 2019

(51) Int. Cl. G09G 5/14; G09G 3/34; G09G 5/32; G09G 3/20

(52) U.S. Cl. CPC G09G 5/14; G09G 3/3453; G09G 5/32; G09G 3/2003; G09G 3/2096; G09G 2340/0464; G09G 2330/023; G09G 2354/00; G09G 2320/0606; G09G 2340/045; G09G 2340/0492; G09G 2300/023

(57) ABSTRACT

A display method and an electronic device are provided in embodiments of the disclosure. The method includes determining whether a text content is contained in screen contents to be displayed after the screen contents to be displayed are received; driving an electronic ink display screen of the electronic device to display the text content at a first display area, and driving a transparent display screen of the electronic device to display the remaining content of the screen contents other than the text content at a second display area if the text content is determined to be contained in the screen contents, wherein the first display area and the second display area are not overlapped; driving the transparent display screen to display the screen contents if no text content is determined to be contained in the screen contents. It can be seen that, embodiments of the present disclosure are beneficial to display the screen contents integrating display characteristics of the plurality of display screens disposed by the electronic device, which can save the display power consumption of the electronic device.

### RELATED APPLICATION

The present application is a National Phase of International Application Number PCT/CN2016/112105, filed Dec. 26, 2016.

### TECHNICAL FIELD

The present disclosure relates to a field of screen displaying, and more particularly, to a display method and an electronic device.

### BACKGROUND

With the development of display technology, a plurality of display screens can be stacked on an existing electronic device; for example, a transparent display screen and an electronic ink display screen can be stacked on an electronic device. The transparent display screen is located above the electronic ink display screen along to a user's viewing direction. The transparent display screen is used to display contents with higher image color requirement, such as photos or videos. The electronic ink display screen is used to display text contents such as documents or e-books. However, existing electronic devices can only display different screen contents by switching different display screens. If the screen contents to be displayed include both text content and image content, the electronic device can only use the transparent display screen to display the screen contents, instead of displaying the screen contents taking advantage of displaying characteristics of the electronic ink display screen. At this point, the electronic device can only display the text content through the transparent display screen, increasing display power consumption thereof.

### SUMMARY

The present disclosure provides a display method and an electronic device, which are beneficial to display the screen contents taking advantage of the display characteristics of the plurality of display screens by the electronic device, and then can reduce the display power consumption of the electronic device.

In a first aspect, an embodiment of the present disclosure provides a display method for screen contents, including:

Determining whether a text content is contained in screen contents to be displayed after the screen contents to be displayed are received;

Driving an electronic ink display screen of the electronic device to display the text content at a first display area, and driving a transparent display screen of the electronic device to display the remaining content of the screen contents other than the text content at a second display area if the text content is determined to be contained in the screen contents, wherein the first display area and the second display area are not overlapped; and

Driving the transparent display screen to display the screen contents if no text content is determined to be contained in the screen contents.

Optionally, before driving the electronic ink display screen of the electronic device to display the text content at the first display area, and driving the transparent display screen of the electronic device to display the remaining content of the screen content other than the text content at the second display area if the text content is determined to be contained in the screen content:

Detecting whether a text attribute of the text content belongs to a pre-authorization text attribute set, wherein the pre-authorization text attribute set comprises text attributes pre-authorized to display on the electronic ink display screen by a user;

The driving the electronic ink display screen of the electronic device to display the text content at the first display area includes:

Driving the electronic ink display screen of the electronic device to display the text content at the first display area if the text attribute of the text content belongs to the pre-authorized text attribute set.

Optionally, detecting whether the text attribute of the text content belongs to a pre-authorization text attribute set:

Determining whether current power of the electronic device is lower than a preset threshold if no text attribute of the text content is detected to belong to the pre-authorized text attribute set;

The driving the electronic ink display screen of the electronic device to display the text content at the first display area includes:

Driving the electronic ink display screen of the electronic device to display the text content at the first display area if the current power is lower than the preset threshold.

Optionally, the driving the electronic ink display screen of the electronic device to display the text content at the first display area, and driving the transparent display screen of the electronic device to display the remaining content of the screen contents other than the text content at the second display area includes:

Transmitting content data of the text content to a driving unit of the electronic ink display screen, such that the driving unit of the electronic ink display screen drives the electronic ink display screen to display the text content at the first display area corresponding to the content data of the text content;

Setting pixel color data of the text content as black pixel data by changing content data of the screen contents, wherein the black pixel data corresponds to the transparent display state of the transparent display screen;

Transmitting content data of the screen contents, which have been changed, to a driving unit of the transparent display screen, such that the driving unit of the transparent display screen drives the transparent display screen to display the screen contents, which have been changed.

Optionally, the driving the electronic ink display screen of the electronic device to display the text content at the first display area, and driving the transparent display screen of the electronic device to display the remaining content of the screen contents other than the text content at the second display area includes:

Transmitting content data of the text content to a driving unit of the electronic ink display screen, thus that the driving unit of the electronic ink display screen drives the electronic ink display screen to display the text content at the first display area corresponding to the content data of the text content;

Deleting the content data of the text content from content data of the screen contents to obtain content data of the remaining content;

Transmitting the content data of the remaining content to a driving unit of the transparent display screen, thus that the driving unit of the transparent display screen drives the transparent display screen to display the remaining content at the second display area corresponding to the content data of the remaining content.

Optionally, the driving the electronic ink display screen of the electronic device to display the text content at the first display area, and driving the transparent display screen of the electronic device to display the remaining content of the screen contents other than the text content at the second display area includes:

Receiving an adjusting operation at the first display area input by a user;

Adjusting the first display area of the electronic ink display screen according to the adjusting operation, and adjusting the second display area of the transparent display screen according to an adjustment of the first display area of the electronic ink display screen.

Optionally, the adjusting operation includes at least one of operations for enlarging, reducing, rotating and moving a display area.

In a second aspect, an embodiment of the present disclosure provides an electronic device that includes:

A confirmation unit configured to determine whether a text content is contained in screen contents after the screen contents to be displayed are received;

A first driving unit configured to drive an electronic ink display screen of the electronic device to display the text content at a first display area if the text content is determined to be contained in the screen contents by the confirmation unit; and

A second driving unit configured to drive a transparent display screen to display the remaining content of the screen contents other than the text content at a second display area if the text content is determined to be contained in the screen contents by the confirmation unit, and to drive the transparent display screen to display the screen contents if no text content is determined to be contained in the screen contents by the confirmation unit, wherein the first display area and the second display area are not overlapped.

Optionally, the electronic device further includes:

A first detecting unit configured to detect whether a text attribute of the text content belongs to a pre-authorized text attribute set if the text content is determined to be contained in the screen contents by the confirmation unit, wherein the pre-authorization text attribute set comprises text attributes pre-authorized to display on the electronic ink display screen by a user;

The first driving unit is further configured to drive the first display area of the electronic ink display screen of the electronic device to display the text content if the text attribute of the text content is detected to belong to the pre-authorized text attribute set by the first detecting unit.

Optionally, the electronic device further includes:

A second detecting unit configured to detect whether current power of the electronic device is lower than a preset threshold if no text attribute of the text content is detected to belong to the pre-authorized text attribute set by the first detecting unit;

The first driving unit is further configured to drive the first display area of the electronic ink display screen of the electronic device to display the text content if the current power of the electronic device is detected lower than the preset threshold by the second detecting unit.

Optionally, the first driving unit is specifically configured to:

Transmit content data of the text content to a driving unit of the electronic ink display screen, such that the driving unit of the electronic ink display screen drives the first display area of the electronic ink display screen to display the text content;

Set pixel color data of the text content as black pixel data by changing content data of the screen contents, wherein the black pixel data corresponds to the transparent display state of the transparent display screen;

Transmit the content data of the screen contents, which have been changed, to a driving unit of the transparent display screen, such that the driving unit of the transparent display screen drives the transparent display screen to display the screen contents, which have been changed.

Optionally, the first driving unit is specifically configured to:

Transmit the content data of the text content to a driving unit of the electronic ink display screen, thus that the driving unit of the electronic ink display screen drives the electronic ink display screen to display the text content at the first display area corresponding to the content data of the text content;

Delete the content data of the text content from content data of the screen contents to obtain content data of the remaining content;

Transmit the content data of the remaining content to a driving unit of the transparent display screen, thus that the driving unit of the transparent display screen drives the transparent display screen to display the remaining content at the second display area corresponding to the content data of the remaining content.

Optionally, the electronic device further includes:

A receiving unit configured to receive an adjustment operation at the first display area input by a user; and

An adjusting unit configured to adjust the first display area of the electronic ink display screen according to the adjusting operation, and to adjust the second display area of the transparent display screen according to an adjustment of the first display area of the electronic ink display screen.

Optionally, the adjusting operation includes at least one of operations for enlarging, reducing, rotating and moving a display area.

In a third aspect, an embodiment of the present disclosure provides an electronic device, including a processor, a storage, an electronic ink display screen, a transparent display screen and a communication bus, wherein the processor, the storage, the electronic ink display screen and the transparent display screen are coupled through the communication bus; the storage stores executable programs; the transparent display screen covers the electronic ink display screen; the processor is configured to support the electronic device to perform the corresponding function of the method provided by the first aspect.

In a fourth aspect, an embodiment of the present disclosure provides a computer storage medium for storing computer software instructions for use in the electronic device provided by the third aspect, which comprises a program for performing the method in the first aspect.

In the embodiments of the present disclosure, after the screen contents to be displayed are received, whether the text content is contained in screen contents to be displayed may be determined. If the text content is determined to be contained in the screen content, the electronic ink display screen is driven to display the text content at the first display area, and the transparent display screen is driven to display the remaining content of the screen contents other than the text content at the second display area. Therefore, the electronic device can integrate display characteristics of the plurality of display screens, which can save display power consumption of the electronic device while ensuring the display effect. In addition, the text content is displayed through the electronic ink display screen, which can protect the user's vision and improve the user's viewing experiences.

These and other aspects of the present disclosure will be more simple and easy to be understood in the following description of the embodiments.

### BRIEF DESCRIPTION OF THE DRAWINGS

In order to more clearly explain technical solutions in the embodiments of the present disclosure, drawings that need to be used in the embodiments will be briefly introduced below. Obviously, the drawings in the following description are only some embodiments of the present disclosure. For those ordinarily skilled in the field, other drawings can be obtained without paying creative work.

FIG. 1 is a schematic flowchart of a display method according to an embodiment of the present disclosure.

FIG. 2 is a schematic flowchart of another display method according to an embodiment of the present disclosure.

FIG. 3 is a schematic view of units of an electronic device according to an embodiment of the present disclosure.

FIG. 4 is a schematic structure of an electronic device according to an embodiment of the present disclosure.

FIG. 5 is a schematic partial structure of another electronic device according to an embodiment of the present disclosure.

FIG. 6 is a schematic display effect of screen contents of an electronic device according to an embodiment of the present disclosure.

FIG. 7 is a schematic display effect of screen contents of another electronic device according to an embodiment of the present disclosure.

### DETAILED DESCRIPTION

In order to enable those skilled in the field to better understand the solution of the present disclosure, the technical solution will now be described in detail with reference to the accompanying drawings of the embodiments. It is to be understood that the specific embodiments described herein are merely illustrative of the disclosure and are not all embodiments. Any other embodiments that can be obtained by those ordinarily skilled in the field without creative work according to the embodiments in the present disclosure shall be all covered within the protection of the disclosure.

The terms “first”, “second”, “third”, and “fourth” used in the specification, the claims, and the accompany drawings of the present disclosure are used for distinguishing between different objects rather than describing a particular order. The terms “include”, and “comprise” as well as variations thereof are intended to cover non-exclusive inclusion. For example, a process, method, system, product, or apparatus including a series of steps or modules is not limited to the listed steps or modules, it can optionally include other steps or modules that are not listed; alternatively, other steps or modules inherent to the process, method, product, or device can be included either.

The term “embodiment” referred to herein means that a particular feature, structure, or feature described in connection with the embodiment may be contained in at least an embodiment of the present disclosure. The phrase appearing in various places in the specification does not necessarily refer to the same embodiment, nor does it refer an independent or alternative embodiment that is mutually exclusive with other embodiments. It is expressly and implicitly understood by those skilled in the art that an embodiment described herein may be combined with other embodiments.

Embodiments of the present application will be described below with reference to the accompanying drawings.

First, the method embodiment in the embodiment of the present disclosure are described in detail. The method embodiment of the present disclosure can be implemented by the electronic device disclosed in the embodiment of the present disclosure. The electronic device described in the embodiment of the present disclosure at least includes a transparent display screen and an electronic ink display screen, where the transparent display screen includes at least one of transparent OLED (Organic Light-Emitting Diode) display screens, transparent LCD (Liquid Crystal Display) and other transparent display screens. The transparent display screen of the electronic device covers the electronic ink display screen. The electronic device disclosed in the embodiments of the present disclosure includes, but is not limited to, a mobile phone, a tablet computer, a notebook computer, a palmtop computer, a mobile internet device (MID), a wearable device (such as a smart watch (such as iwatch), and a smart band, etc.) or other electronic devices.

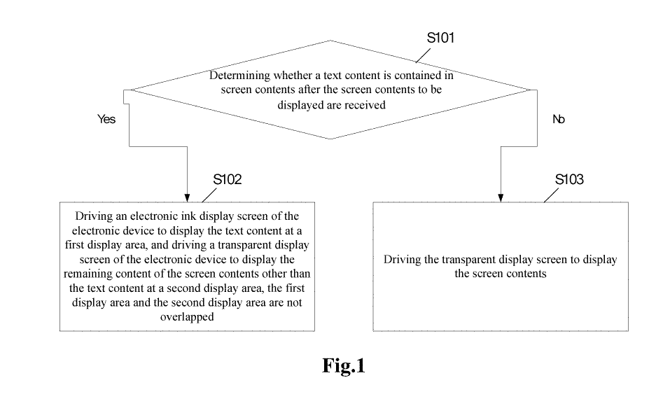

Referring to FIG. 1, FIG. 1 is a schematic flow chart of a display method according to an embodiment of the present disclosure. The display method can be implemented by an electronic device having at least two layered display screens. As shown in FIG. 1, the display method includes actions at least defined by the following blocks.

At block 101, whether a text content is contained in screen contents to be displayed is determined after the screen contents to be displayed are received.

In an embodiment, the electronic device can receive the screen contents to be displayed and determine whether a text content is contained in the screen contents. Specifically, a frame image, a web page, an application interface, a document display page, and the like in video stream or image stream may be contained in the screen contents to be displayed. The electronic device can receive the screen contents to be displayed, or can receive the screen contents transmitted by application installed in the electronic device through a network. The screen contents to be displayed may specifically be content data thereof, and pixel color data and pixel coordinate data constituting the screen contents are contained in the content data. Where the electronic device can determine whether a text content is contained in the screen contents by determining whether a text control with text attribute is contained in the screen contents, alternatively whether area of the text content in the screen contents exceeds a preset area, etc.. If the determination result is yes, the electronic device determines that a text content is contained in the screen contents. Of course, the embodiment of the present disclosure may further include other methods for determining whether a text content is contained in the screen contents, and is not limited to the embodiment of the present disclosure. It should be noted that the text content described in the embodiment of the present disclosure is a display content that can be displayed by the electronic ink display screen, and cannot only be a character content but can also be an image content, an control content, and the like, which is not limited herein.

At block 102, if the electronic device determines that a text content is contained in the screen contents, the electronic ink display screen of the electronic device is driven to display the text content at a first display area, and the transparent display screen of the electronic device is driven to display the remaining content of the screen contents other than the text content at a second display area. The first display area and the second display area are not overlapped.

In an embodiment, if the electronic device determines that the text content is contained in the screen contents, the electronic ink display screen of the electronic device can be driven to display the text content at the first display area, and the transparent display screen of the electronic device can be driven to display the remaining content of the screen contents other than the text content at the second display area. The first display area and the second display area are not overlapped. Specifically, content data of the text content may be extracted and transmitted to a driving unit of the electronic ink display screen, thus that the driving unit of the electronic ink display screen drives corresponding pixel points to display the text content on the electronic ink display screen according to the transmitted content data of the text content. Content data of the remaining content may be transmitted to a driving unit of the transparent display screen, thus that the driving unit of the transparent display screen drives corresponding pixel points to display the remaining content on the transparent display screen according to the content data of the remaining content. Alternatively, after the content data of the text content is transmitted to the driving unit of the electronic ink display screen, the content data of the text content then can be changed, and the content data of the screen contents, which have been changed, can be transmitted to the driving unit of the transparent display screen. Since the content data of the text content in the screen contents has been changed, the driving unit of the transparent display screen will not drive the corresponding pixel points to display the text content, that is, the display area which ought to display the text content will still be in a transparent display state.

Where, the first display area of the electronic ink display screen may be determined according to text pixel coordinates of the content data of the text content, alternatively, the first display area of the electronic ink display screen may be determined according to an operation instruction input by a user, for example, a touch operation of the user is received, and the first display area may be determined according to an operation area of the touch operation. Thus, a display format of the text content, such as a font size of the text content and the like, can be changed through changing the content data of the text content, to accommodate the first display area of the electronic ink display screen determined by the user.

The second display area may be determined according to the determined first display area. For example, the display screen is composed of the first display area and the second display area, and after the first display area is determined, the remaining display area of the display screen other than the first display area then can be defined to be the second display area. Alternatively, the second display area can be determined according to the content data of the remaining content, that is, the second display area can be determined according to the pixel coordinate of the remaining content. Alternatively, the second display area can be determined according to an operation instruction input by a user.

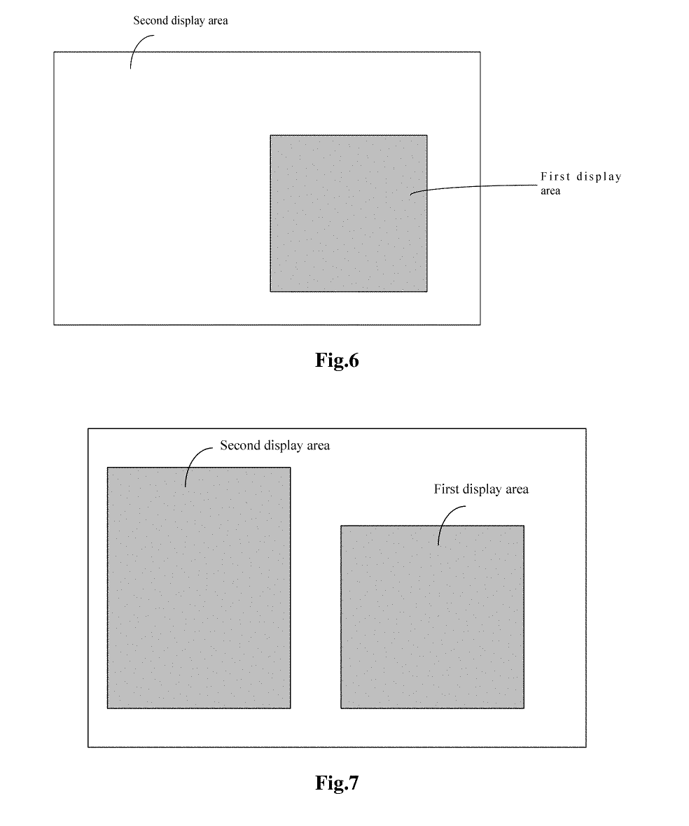

Specific display effect can be shown in schematic views of display effect in FIG. 6 or FIG. 7.

FIG. 6 shows a schematic effect of screen contents of an electronic device according to an embodiment of the present disclosure. Where, the display screen is composed of a first display area and a second display area. The electronic ink display screen displays the text content at the first display area, and the transparent display screen displays the remaining content at the second display area of the display screen other than the first display area. The electronic ink display screen may display a pure white image, a pure black image, a specific format image, or the like at the second display area, and the content displayed by the electronic ink display screen at the second display area may not be changed as the text content changes. The transparent display screen at the first display area is in a transparent display state, which may avoid hindering the user from viewing the text content; alternatively, the transparent display screen displays a specific image or a specific color at the first display area to enhance the display effect of the text content displayed on the electronic ink display screen. Optionally, the transparent display screen can display a specific image or a specific color at the first display area when receiving the user's instruction; alternatively, the transparent display screen can detect environment to determine whether the environment meets a display condition, and when the environment meets the display condition, the transparent display screen can display a specific image or a specific color at the first display area.

FIG. 7 shows a schematic display effect of screen contents of another electronic device according to an embodiment of the present disclosure. The first display area and the second display area are not overlapped and both are independent display areas. Where the electronic ink display screen displays the text content at the first display area, and the transparent display screen displays the remaining content of the screen contents at the second display area. The electronic ink display screen may display a pure white image, a pure black image, a specific format image, or the like in the display screen other than the first display area. The transparent display screen is in a transparent display state in the display screen other than the second display area, that is the driving unit do not drive the pixel point to give out light in the display screen other than the second display area, thereby further saving the display power consumption of the electronic device. As described in the above embodiment, the second display area shown in FIG. 7 may be determined by an operation instruction input by a user or determined by the content data of the remaining content.

At block 103, if no text content is determined to be contained in the screen contents, the transparent display screen is driven to display the screen contents.

In an embodiment, if no text content is determined to be contained in the screen contents, the transparent display screen can be driven to display the screen contents. And screen contents to be displayed in a next frame are further determined through the above actions.

In an embodiment, if no text content is determined to be contained in the screen contents, whether a content, which can be displayed by the electronic ink display screen, is contained in the screen contents can be further determined. Specifically, a content set that can be displayed by the electronic ink display screen can be preset, and whether a content of the content set is contained in the screen contents can be determined. If yes, the content of the content set can be displayed on the electronic ink display screen; if not, the transparent display screen can be driven to display the screen contents. In other embodiments, current power of the electronic device can be determined. If the current power is lower than a preset threshold, the electronic ink display screen is driven to display the screen contents; if the current power is greater than the preset threshold, the transparent display screen is driven to display the screen contents.

In the embodiment of the present disclosure, after the screen contents to be displayed are received, whether the text content is contained in screen contents to be displayed may be determined. If the text content is determined to be contained in the screen content, the electronic ink display screen is driven to display the text content at the first display area, and the transparent display screen is driven to display the remaining content of the screen contents other than the text content at the second display area. Therefore, the electronic device can integrate display characteristics of the plurality of display screens, which can save display power consumption of the electronic device while ensuring the display effect. In addition, the text content is displayed through the electronic ink display screen, which can protect the user's vision and improve the user's viewing experiences.

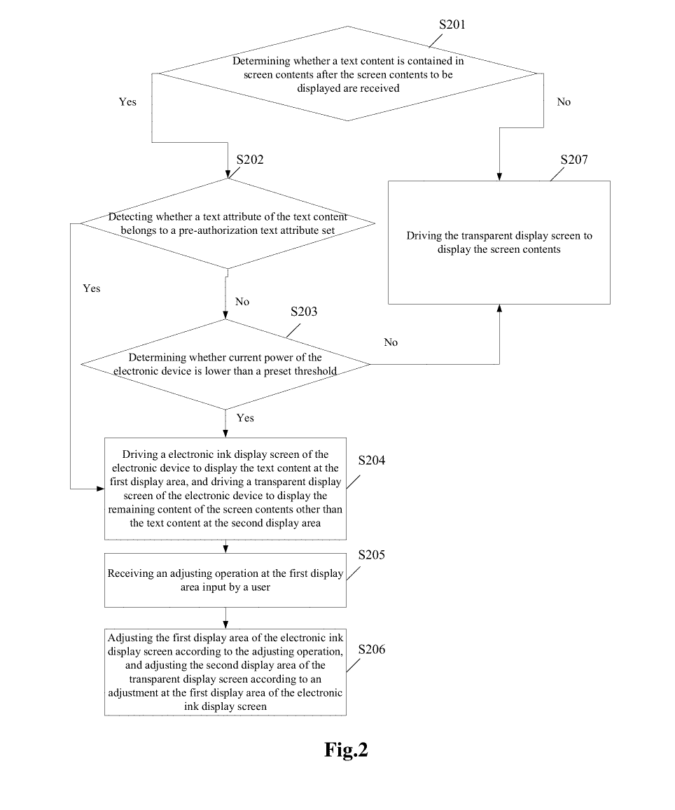

Referring to FIG. 2, FIG. 2 is a schematic flow chart of another display method according to an embodiment of the present disclosure. As shown in FIG. 2, the method includes actions at least defined by the following blocks.

At block 201, when screen contents to be displayed are received, whether a text content is contained in the screen contents to be displayed is determined.

In an embodiment, if a text content is determined to contained in the screen contents, actions defined by block 202 are performed; if no text content is determined to contained in the screen contents, actions defined by block 207 are performed.

At block 202, if the text content is determined to contained in the screen contents, whether a text attribute of the text content belongs to a pre-authorization text attribute set is detected. The pre-authorization text attribute set includes text attributes pre-authorized to be displayed on the electronic ink display screen by a user.

In an embodiment, after the text content is determined to contained in the screen contents, whether the text attribute of the text content belongs to the pre-authorization text attribute set can further be detected. The pre-authorization text attribute set includes text attributes pre-authorized to be displayed on the electronic ink display screen by a user. Specifically, in order to ensure the display effect of the display screen, the user may pre-authorize text contents having at least one text attribute to be displayed on the electronic ink screen. Text attributes authorized by the user can form a pre-authorization text attribute set and can be saved in the electronic device. After the text content is determined to contained in the screen contents, that is after the screen contents are determined to include text content which can be displayed by the electronic ink display screen, a text attribute of the text content may be further detected. If the text attribute of the text content belongs to the pre-authorized text attribute set, the text content is indicated to be authorized to be displayed on the electronic ink display screen; therefore actions defined by block 204 may be performed. If no text attribute of the text content belongs to the pre-authorized text attribute set, actions defined by block 203 may be performed.

At block 203, whether current power of the electronic device is lower than a preset threshold is determined if no text attribute of the text content is detected to belong to the pre-authorized text attribute set.

In an embodiment, if no text attribute of the text content is detected to belong to the pre-authorized text attribute set, current power of the electronic device can be further detected. If the current power is lower than a preset threshold, actions defined by block 204 may be performed to save the display power consumption. If the current power is greater than the preset threshold, actions defined by block 207 may be performed to display all the screen contents on the transparent display screen.

At block 204, if the text attribute of the text content is detected to belong to the pre-authorized text attribute set, alternatively if the current power is lower than the preset threshold, the electronic ink display screen of the electronic device is driven to display the text content at the first display area, and the transparent display screen of the electronic device is driven to display the remaining content of the screen contents other than the text content at the second display area.

In an embodiment, after the text content is determined to meet the display condition on the electronic ink display screen by the above manner, the electronic ink display screen of the electronic device can be driven to display the text content at the first display area, and the transparent display screen of the electronic device can be driven to display the remaining content of the screen contents other than the text content at the second display area.

Specifically, the actions defined by the block 204 can be implemented in any of the following ways:

(1) Content data of the text content is transmitted to a driving unit of the electronic ink display screen; thus that the driving unit of the electronic ink display screen can drive the electronic ink display screen to display the text content at the first display area corresponding to the content data of the text content.

Pixel color data of the text content is set as black pixel data by changing content data of the screen contents. The black pixel data corresponds to the transparent display state of the transparent display screen.

Content data of the screen contents, which have been changed, is transmitted to a driving unit of the transparent display screen; thus that the driving unit of the transparent display screen drives the transparent display screen to display the screen contents, which have been changed.

Specifically, the content data of the text content may include pixel coordinate data and pixel color data, thus that the driving units of the display screen may display corresponding pixel data on corresponding pixel coordinates according to the content data. Thus that, the content data of the text content can be transmitted to the driving unit of the electronic ink display screen, and the drive unit can display the text content according to the pixel coordinate data and the pixel color data of the content data; thus that the electronic ink display screen can be driven to display the text content. In an embodiment of the present disclosure, the first display area can be determined by the pixel coordinate data of the content data. For example, if the pixel coordinate data is determined to be x₀≤x≤x₁, y₀≤y≤y₁ by the content data of the text content, the area according to the pixel coordinate data is determined to be the first display area. The electronic ink display screen can display the text content at the first display area. After the text content is transmitted to the driving unit of the electronic ink display screen, the content data of the text content of the screen contents can be changed, the pixel color data of the text content is set as black pixel data, and the black pixel data corresponds to the transparent display state of the transparent display screen. For example, the pixel color data corresponding to the text content may be set to black pixel data, which is usually 0. After the content data of the text content of the screen contents is changed, the content data of the screen contents, which have been changed, is transmitted to the driving unit of the transparent display screen, and when the pixel color data is detected by the driving unit, the pixel points of the corresponding pixel coordinates may not be driven to display; thus that the transparent display screen on positions corresponding to the text content is in a transparent display state. In an embodiment of the present disclosure, the second display area and the first display area form the display screen, and the second display area and the first display area are complementary.

(2) Content data of the text content is transmitted to the driving unit of the electronic ink display screen; thus that the driving unit of the electronic ink display screen drives the electronic ink display screen to display the text content at the first display area corresponding to the content data of the text content.

The content data of the text content is deleted from content data of the screen contents to obtain content data of the remaining content.

The content data of the remaining content is transmitted to the driving unit of the transparent display screen; thus that the driving unit of the transparent display screen drives the transparent display screen to display the remaining content at the second display area corresponding to the content data of the remaining content.

Specifically, the content data of the text content may be extracted from the content data of the screen contents, and the content data of the text content can be transmitted to the driving unit of the electronic ink display screen; thus that the driving unit drives the pixel points of the corresponding pixel coordinates to be colored according to the content data of the text content. The content data of the remaining content of the screen contents is transmitted to the driving unit of the transparent display screen; thus that the driving unit drives the pixel points of the corresponding pixel coordinates to be colored according to the content data of the remaining content.

Of course, other ways may also be performed to drive the display screen to display the screen contents, which are not listed here.

At block 205, an adjusting operation of a user at the first display area is received.

In an embodiment, after the electronic ink display screen and the transparent display screen is driven together to display the screen contents, an adjusting operation of a user for the first display area can be received. The adjusting operation may include at least one of operations for enlarging, reducing, rotating and moving a display area.

At block 206, the first display area of the electronic ink display screen is adjusted according to the adjusting operation, and the second display area of the transparent display screen is adjusted according to an adjustment of the first display area of the electronic ink display screen.

In an embodiment, the first display area of the electronic ink display screen may be adjusted according to a received adjusting operation for the first display area, and the second display area may be further adjusted according to an adjustment of the first display area. Specifically, if the received adjusting operation is an operation for enlarging the display area, the first display area of the electronic ink display screen is enlarged corresponding to an operation instruction corresponding to the adjusting operation, and the second display area of the transparent display screen may be correspondingly reduced. Similarly, after the adjusting operation is received, the first display area and the second display area may be correspondingly adjusted to clearly display the text content.

Furthermore, after the display areas is adjusted, display formats of the content displayed at the display areas may be correspondingly adjusted to adapt to the adjusted display areas. For example, if the first display area is enlarged, the display format of the text content may be further adjusted, such as enlarging the font size or the display image. Accordingly, if the second display area is reduced, the display format of the remaining content of the screen contents may be further adjusted, such as reducing the image or the font size.

At block 207, if no text content is determined to contained in the screen contents, alternatively if no text attribute of the text content belongs to the pre-authorized text attribute set and the current power of the electronic device is greater than the preset threshold, the transparent display screen is driven to display the screen contents.

In the embodiment of the present disclosure, after the screen contents to be displayed are received, whether the text content is contained in screen contents to be displayed may be determined. If the text content is determined to be contained in the screen content, the electronic ink display screen is driven to display the text content at the first display area, and the transparent display screen is driven to display the remaining content of the screen contents other than the text content at the second display area. Therefore, the electronic device can integrate display characteristics of the plurality of display screens, which can save display power consumption of the electronic device while ensuring the display effect. In addition, the text content is displayed through the electronic ink display screen, which can protect the user's vision and improve the user's viewing experiences.

Device embodiments in present disclosure are detailed below combining with the above method embodiments.

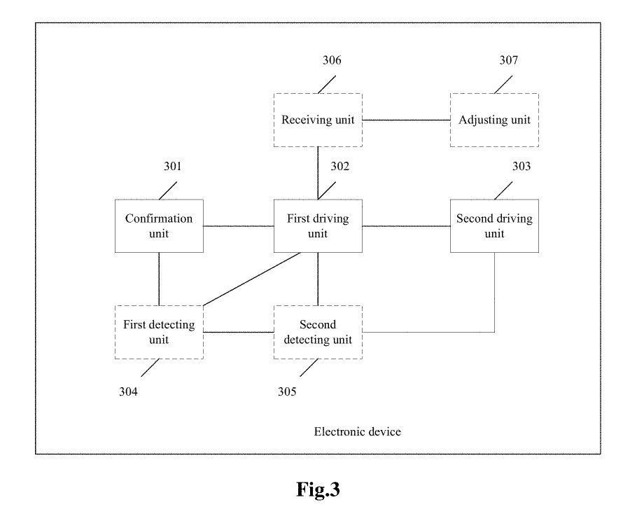

Referring to FIG. 3, FIG. 3 is a block diagram of an electronic device according to an embodiment of the present disclosure. The electronic device includes a confirmation unit 301, a first driving unit 302, and a second driving unit 303.

The confirmation unit 301 is configured to determine whether a text content is contained in screen contents after the screen contents to be displayed are received.

The first driving unit 302 is configured to drive an electronic ink display screen of the electronic device to display the text content at a first display area, and the second driving unit 303 is configured to drive a transparent display screen to display the remaining content of the screen contents other than the text content at a second display area if the confirmation unit determines that a text content is contained in screen contents. Where the first display area and the second display area are not overlapped.

The second driving unit 303 is further configured to drive the transparent display screen to display the screen contents if the confirmation unit determines that no text content is contained in screen contents.

In an embodiment, the electronic device further includes a first detecting unit 304.

The first detecting unit 304 is configured to detect whether a text attribute of the text content belongs to a pre-authorized text attribute set if the confirmation unit 301 determines that the text content is contained in screen contents. Where the pre-authorization text attribute set includes text attributes which are pre-authorized to display on the electronic ink display screen by a user.

The first driving unit 302 is further configured to drive the electronic ink display screen of the electronic device to display the text content at the first display area if the first detecting unit 304 detects that the text attribute of the text content belongs to the pre-authorized text attribute set.

In an embodiment, the electronic device further includes a second detecting unit 305.

The second detecting unit 305 is configured to detect whether current power of the electronic device is lower than a preset threshold if the first detecting unit detects that no text attribute of the text content belongs to the pre-authorized text attribute set.

The first driving unit 302 is further configured to drive the electronic ink display screen of the electronic device to display the text content at the first display area if the second detecting unit 305 detects that the current power of the electronic device is lower than the preset threshold.

In an embodiment, the first driving unit 302 is specifically configured to transmit content data of the text content to a driving unit of the electronic ink display screen; thus that the driving unit of the electronic ink display screen drives the electronic ink display screen to display the text content at the first display area.

The first driving unit 302 is specifically configured to set pixel color data of the text content as black pixel data by changing content data of the screen contents. Where the black pixel data corresponds to the transparent display state of the transparent display screen.

The first driving unit 302 is specifically configured to transmit the content data of the screen contents, which have been changed, to a driving unit of the transparent display screen; thus that the driving unit of the transparent display screen drives the transparent display screen to display the screen contents, which have been changed

In an embodiment, the first driving unit 302 is specifically configured to transmit the content data of the text content to a driving unit of the electronic ink display screen; thus that the driving unit of the electronic ink display screen drives the electronic ink display screen to display the text content at the first display area corresponding to the content data of the text content.

The first driving unit 302 is specifically configured to delete the content data of the text content from the content data of the screen contents to obtain content data of the remaining content.

The first driving unit 302 is specifically configured to transmit the content data of the remaining content to a driving unit of the transparent display screen; thus that the driving unit of the transparent display screen drives the transparent display screen to display the remaining content at the second display area corresponding to the content data of the remaining content.

In an embodiment, the electronic device further includes a receiving unit 306 and an adjusting unit 307.

The receiving unit 306 is configured to receive an adjustment operation at the first display area input by a user.

The adjusting unit 307 is configured to adjust the first display area of the electronic ink display screen according to the adjusting operation, and to adjust the second display area of the transparent display screen according to an adjustment of the first display area of the electronic ink display screen.

In the embodiment of the present disclosure, the above functional units are configured to implement specific implementation of corresponding actions in the above method embodiments. It will not be repeated here.

Referring to the above embodiments, the electronic device is presented in a unit form. A “unit” herein may refer to an application-specific integrated circuit (ASIC), a processor and a storage that execute one or more software or firmware programs, integrated logic circuits, and/or other devices that provide functions described above.

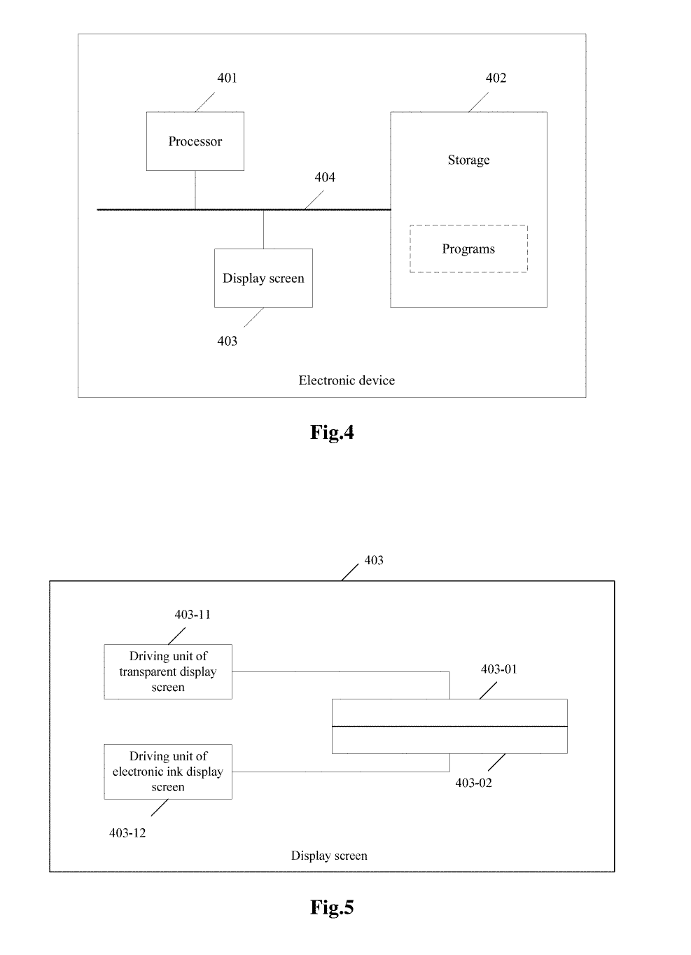

In an embodiment, those skilled in the art will appreciate that the electronic device shown in FIG. 3 can be presented in a form shown in FIG. 4 below.

As shown in FIG. 4, the electronic device can be implemented with the structure of FIG. 4. The electronic device can include a processor 401, a storage 402, a display screen 403, and a communication bus 404. The processor 401, the storage 402, and the display screen 403 are coupled through the communication bus 404.

The storage stores executable programs.

The display screen 403 includes a transparent display screen 403-01 and an electronic ink display screen 403-02. The transparent display screen 403-01 covers the electronic ink display screen 403-02.

The display screen 403 may further include a driving unit 403-11 of the transparent display screen and a driving unit 403-12 of the electronic ink display screen. The structure of the display screen 403 can be referred to the structural diagram shown in FIG. 5.

The storage 402 is configured to store programs, and the processor 401 can invoking the executable programs stored in the storage to perform the following actions:

Whether a text content is contained in screen contents is determined after the screen contents to be displayed are received.

If the electronic device determines that a text content is contained in screen contents, the electronic ink display screen of the electronic device is driven to display the text content at the first display area, and the transparent display screen of the electronic device is driven to display the remaining content of the screen contents other than the text content at the second display area. The first display area and the second display area are not overlapped.

If no text content is determined to be contained in screen contents, the transparent display screen is driven to display the screen contents.

In an embodiment, before the processor 401 drives the electronic ink display screen of the electronic device to display the text content at the first display area if a text content is determined to be contained in screen contents, the processor 401 is further configured to invoking the executable programs stored in the storage to perform the following actions:

Whether a text attribute of the text content belongs to a pre-authorization text attribute set is detected. The pre-authorization text attribute set includes text attributes pre-authorized to display on the electronic ink display screen by a user.

The electronic ink display screen of the electronic device is driven to display the text content at the first display area includes the following actions:

If the text attribute of the text content is detected to belong to the pre-authorized text attribute set, the electronic ink display screen of the electronic device is driven to display the text content at the first display area.

In an embodiment, after the processor 401 detected whether the text attribute of the text content belongs to a pre-authorization text attribute set, the processor 401 is further configured to invoking the executable programs stored in the storage to perform the following actions:

Whether current power of the electronic device is lower than a preset threshold is determined, if no text attribute of the text content is detected to belong to the pre-authorized text attribute set.

The electronic ink display screen of the electronic device is driven to display the text content at the first display area includes the following actions:

If the current power of the electronic device is detected to be lower than the preset threshold, the electronic ink display screen of the electronic device is driven to display the text content at the first display area.

In an embodiment, the processor 401 drives the electronic ink display screen of the electronic device to display the text content at the first display area, and drives the transparent display screen of the electronic device to display the remaining content of the screen contents other than the text content at the second display area, specifically includes the following actions:

Content data of the text content is transmitted to a driving unit of the electronic ink display screen; thus that the driving unit of the electronic ink display screen drives the electronic ink display screen to display the text content at the first display area corresponding to the content data of the text content.

Pixel color data of the text content is set as black pixel data by changing content data of the screen contents. The black pixel data corresponds to the transparent display state of the transparent display screen.

Content data of the screen contents, which have been changed, is transmitted to a driving unit of the transparent display screen; thus that the driving unit of the transparent display screen drives the transparent display screen to display the screen contents, which have been changed.

In an embodiment, the processor 401 drives the electronic ink display screen of the electronic device to display the text content at the first display area, and drives the transparent display screen of the electronic device to display the remaining content of the screen contents other than the text content at the second display area, specifically includes the following actions:

Content data of the text content is transmitted to a driving unit of the electronic ink display screen; thus that the driving unit of the electronic ink display screen drives the electronic ink display screen to display the text content at the first display area corresponding to the content data of the text content.

The content data of the text content is deleted from content data of the screen contents to obtain content data of the remaining content.

The content data of the remaining content is transmitted to a driving unit of the transparent display screen; thus that the driving unit of the transparent display screen drives the transparent display screen to display the remaining content at the second display area corresponding to the content data of the remaining content.

In an embodiment, after the processor 401 drives the electronic ink display screen of the electronic device to display the text content at the first display area, and drives the transparent display screen of the electronic device to display the remaining content of the screen contents other than the text content at the second display area, the processor 401 is further configured to invoking the executable programs stored in the storage to perform the following actions:

An adjusting operation for the first display area input by a user is received.

The first display area of the electronic ink display screen is adjusted according to the adjusting operation, and the second display area of the transparent display screen is adjusted according to an adjustment on the first display area of the electronic ink display screen.

The adjusting operation may include at least one of operations for enlarging, reducing, rotating and moving a display area.

In the embodiments of the present disclosure, the processor 401 may be a general-purpose central processing unit (CPU), a microprocessor, an application-specific integrated circuit (ASIC), or one or more integrated circuit for controlling the execution of the above program.

The storage 402 may be a read-only memory (ROM) or other static storage devices that may store static information and instructions, a random access memory (RAM) or other dynamic storage devices that may store information and instructions, and may also be an Electrically Erasable Programmable Read-Only Memory (EEPROM), a Compact Disc Read-Only Memory, CD-ROM), or, may be other CD Memories, CD-ROM Memories (including compact disks, laser disks, optical disks, digital versatile disks, Blue-ray disks, etc.), magnetic disk storage medias or other magnetic storage devices, or any other medias that can be used to carry or store desired program code in a form of instructions or data structures and can be accessed by a computer, but is not limited thereto. The storage 402 may exist independently and be coupled to the processor 401 through a bus. The storage 402 may also be integrated with the processor 401.

The embodiment of the disclosure further provides a non-transitory computer-readable storage medium. The non-transitory computer-readable storage medium is configured to store computer software instructions for the electronic device, which comprises computer programs for performing the above method embodiments.

Although the present disclosure described herein is combined with the above embodiments, it will be understood by those skilled in the art that other variations of disclosed embodiments can be achieved by viewing the drawings, the disclosure content and the claims, in a process of carrying out the disclosure to be protected. In claims, the word “comprising” does not exclude other components or actions, and “a” or “an” does not exclude a plurality. A single processor or other unit may fulfill several of the functions recited in the claims. Certain measures are recited in mutually different dependent claims, however that does not mean that the measures cannot be combined to produce a good effect.

Those skilled in the art will appreciate that embodiments of the present disclosure can be provided as methods, apparatus (device), or computer program products. Accordingly, the present disclosure may take forms of entirely hardware embodiments, entirely software embodiments, or combination embodiments of software and hardware. Moreover, the disclosure can perform computer programs on one or more computer-usable storage medium (including but not limited to disk storages, CD-ROMs, optical storages, etc.) including computer usable program codes. The computer programs are stored/distributed in a suitable medium, and are provided with other hardware or are part of the hardware, or, the computer programs are distributed in other forms, such as over internet or other wired/wireless telecommunication systems.

The present disclosure has been described with reference to flowcharts and/or block diagrams of the methods, apparatus, and products of computer programs of the embodiments. It will be understood that each flow of the flowcharts and/or each block of the block diagrams, and combinations of the flows of the flowcharts and/or blocks of the block diagrams can be implemented by computer program instructions. These computer program instructions can be provided to a processor of a general purpose computer, a special purpose computer, an embedded processor, or other programmable data processing device to produce a machine; therefore a device configured for implementing the specified functions in one or more of the flows in the flowcharts or one or more of the blocks in the block diagrams is produced by a processor of a computer or other programmable data processing device.

The computer program instructions can also be stored in a computer readable storage that can direct a computer or other programmable data processing device to operate in a particular manner, such that the instructions stored in the computer readable storage produce a product including an instruction device. The instruction device implements the specified functions in one or more of the flows in the flowcharts or one or more of the blocks in the block diagrams.

These computer program instructions can also be loaded into a computer or other programmable data processing device, such that a series of operational steps are performed on a computer or other programmable device to produce computer-implemented processing; therefore a process configured for implementing the specified functions in one or more of the flows in the flowcharts or one or more of the blocks in the block diagrams is provided by an instruction performed on a computer or other programmable data processing device.

While the invention has been described with respect to the specific features and embodiments thereof, it will be understood that various modifications and combinations may be carried on without departing from the spirit and scope of the disclosure. Accordingly, the specification and drawings are only implementations of the present disclosure limited by the claims, and is considered to cover any and all modifications, variations, combinations or equivalents within the protection of the disclosure. It will be understood that those skilled in the art can make various modifications and variations to the disclosure without departing from the spirit and scope of the disclosure. Thus, the present disclosure is intended cover any and all the modifications and variations, if the modifications and variations of the disclosure fall into the scope of the claims and equivalent technical solutions of the present disclosure.

1. A display method for screen contents, comprising:
determining whether a text content is contained in screen contents to be displayed after the screen contents to be displayed are received;
driving an electronic ink display screen of the electronic device to display the text content at a first display area, and driving a transparent display screen of the electronic device to display the remaining content of the screen contents other than the text content at a second display area if the text content is determined to be contained in the screen contents, wherein the first display area and the second display area are not overlapped; and
driving the transparent display screen to display the screen contents if no text content is determined to be contained in the screen contents.

2. The display method of claim 1, further comprising:
before driving the electronic ink display screen of the electronic device to display the text content at the first display area, and driving the transparent display screen of the electronic device to display the remaining content of the screen content other than the text content at the second display area if the text content is determined to be contained in the screen content:
detecting whether a text attribute of the text content belongs to a pre-authorization text attribute set, wherein the pre-authorization text attribute set comprises text attributes pre-authorized to display on the electronic ink display screen by a user;
wherein the driving the electronic ink display screen of the electronic device to display the text content at the first display area comprises:
driving the electronic ink display screen of the electronic device to display the text content at the first display area if the text attribute of the text content belongs to the pre-authorized text attribute set.

3. The display method of claim 2, further comprising:
after detecting whether the text attribute of the text content belongs to a pre-authorization text attribute set:
determining whether current power of the electronic device is lower than a preset threshold if no text attribute of the text content is detected to belong to the pre-authorized text attribute set;
wherein the driving the electronic ink display screen of the electronic device to display the text content at the first display area comprises:
driving the electronic ink display screen of the electronic device to display the text content at the first display area if the current power is lower than the preset threshold.

4. The display method of claim 1, wherein the driving the electronic ink display screen of the electronic device to display the text content at the first display area, and driving the transparent display screen of the electronic device to display the remaining content of the screen contents other than the text content at the second display area comprises:
transmitting content data of the text content to a driving unit of the electronic ink display screen, such that the driving unit of the electronic ink display screen drives the electronic ink display screen to display the text content at the first display area corresponding to the content data of the text content;
setting pixel color data of the text content as black pixel data by changing content data of the screen contents, wherein the black pixel data corresponds to the transparent display state of the transparent display screen;
transmitting content data of the screen contents, which have been changed, to a driving unit of the transparent display screen, such that the driving unit of the transparent display screen drives the transparent display screen to display the screen contents, which have been changed.

5. The display method of claim 1, wherein the driving the electronic ink display screen of the electronic device to display the text content at the first display area, and driving the transparent display screen of the electronic device to display the remaining content of the screen contents other than the text content at the second display area comprises:
transmitting content data of the text content to a driving unit of the electronic ink display screen, thus that the driving unit of the electronic ink display screen drives the electronic ink display screen to display the text content at the first display area corresponding to the content data of the text content;
deleting the content data of the text content from content data of the screen contents to obtain content data of the remaining content;
transmitting the content data of the remaining content to a driving unit of the transparent display screen, thus that the driving unit of the transparent display screen drives the transparent display screen to display the remaining content at the second display area corresponding to the content data of the remaining content.

6. The display method of any one of claim 1 to claim 3, wherein the driving the electronic ink display screen of the electronic device to display the text content at the first display area, and driving the transparent display screen of the electronic device to display the remaining content of the screen contents other than the text content at the second display area comprises:
receiving an adjusting operation at the first display area input by a user;
adjusting the first display area of the electronic ink display screen according to the adjusting operation, and adjusting the second display area of the transparent display screen according to an adjustment of the first display area of the electronic ink display screen.

7. The display method of claim 6, wherein the adjusting operation comprises at least one of operations for enlarging, reducing, rotating and moving a display area.

8. An electronic device, comprising:
a confirmation unit configured to determine whether a text content is contained in screen contents after the screen contents to be displayed are received;
a first driving unit configured to drive an electronic ink display screen of the electronic device to display the text content at a first display area if the text content is determined to be contained in the screen contents by the confirmation unit; and
a second driving unit configured to drive a transparent display screen to display the remaining content of the screen contents other than the text content at a second display area if the text content is determined to be contained in the screen contents by the confirmation unit, wherein the first display area and the second display area are not overlapped, wherein the second driving unit is further configured to drive the transparent display screen to display the screen contents if no text content is determined to be contained in the screen contents by the confirmation unit.

9. The electronic device of claim 6, further comprising:
a first detecting unit configured to detect whether a text attribute of the text content belongs to a pre-authorized text attribute set if the text content is determined to be contained in the screen contents by the confirmation unit, wherein the pre-authorization text attribute set comprises text attributes pre-authorized to display on the electronic ink display screen by a user;
wherein the first driving unit is further configured to drive the first display area of the electronic ink display screen of the electronic device to display the text content if the text attribute of the text content is detected to belong to the pre-authorized text attribute set by the first detecting unit.

10. The electronic device of claim 9, further comprising:
a second detecting unit configured to detect whether current power of the electronic device is lower than a preset threshold if no text attribute of the text content is detected to belong to the pre-authorized text attribute set by the first detecting unit;
wherein the first driving unit is further configured to drive the first display area of the electronic ink display screen of the electronic device to display the text content if the current power of the electronic device is detected lower than the preset threshold by the second detecting unit.

11. The electronic device of any one of claim 8 to claim 10, wherein the first driving unit is specifically configured to:
transmit content data of the text content to a driving unit of the electronic ink display screen, such that the driving unit of the electronic ink display screen drives the first display area of the electronic ink display screen to display the text content;
set pixel color data of the text content as black pixel data by changing content data of the screen contents, wherein the black pixel data corresponds to the transparent display state of the transparent display screen;
transmit the content data of the screen contents, which have been changed, to a driving unit of the transparent display screen, such that the driving unit of the transparent display screen drives the transparent display screen to display the screen contents, which have been changed.

12. The electronic device of claim 8, wherein the first driving unit is specifically configured to:
transmit the content data of the text content to a driving unit of the electronic ink display screen, thus that the driving unit of the electronic ink display screen drives the electronic ink display screen to display the text content at the first display area corresponding to the content data of the text content;
delete the content data of the text content from content data of the screen contents to obtain content data of the remaining content;
transmit the content data of the remaining content to a driving unit of the transparent display screen, thus that the driving unit of the transparent display screen drives the transparent display screen to display the remaining content at the second display area corresponding to the content data of the remaining content.

13. The electronic device of claim 8, further comprising:
a receiving unit configured to receive an adjustment operation at the first display area input by a user; and
an adjusting unit configured to adjust the first display area of the electronic ink display screen according to the adjusting operation, and to adjust the second display area of the transparent display screen according to an adjustment of the first display area of the electronic ink display screen.

14. The electronic device of claim 13, wherein the adjusting operation comprises at least one of operations for enlarging, reducing, rotating and moving a display area.

15. An electronic device, comprising a processor, a storage, an electronic ink display screen, a transparent display screen, and a communication bus, wherein the processor, the storage, the electronic ink display screen and the transparent display screen are coupled through the communication bus; the storage stores executable programs; the transparent display screen covers the electronic ink display screen; the processor is configured to invoke the executable programs stored in the storage to perform the following actions:
determining whether a text content is contained in screen contents to be displayed after the screen contents to be displayed are received;
driving an electronic ink display screen of the electronic device to display the text content at a first display area, and driving a transparent display screen of the electronic device to display the remaining content of the screen contents other than the text content at a second display area if the text content is determined to be contained in the screen contents, wherein the first display area and the second display area are not overlapped; and
driving the transparent display screen to display the screen contents if no text content is determined to be contained in the screen contents.

16. The electronic device of claim 15, wherein the processor is further configured to invoke programs stored in the storage to perform the following actions:
before driving the electronic ink display screen of the electronic device to display the text content at the first display area if the text content is determined to be contained in the screen contents:
detecting whether a text attribute of the text content belongs to a pre-authorization text attribute set, wherein the pre-authorization text attribute set comprises text attributes pre-authorized to display on the electronic ink display screen by a user;
wherein the driving the electronic ink display screen of the electronic device to display the text content at the first display area comprises:
driving the electronic ink display screen of the electronic device to display the text content at the first display area if the text attribute of the text content belongs to the pre-authorized text attribute set.

17. The electronic device of claim 16, wherein the processor is further configured to invoke programs stored in the storage to perform the following actions:
after detecting whether the text attribute of the text content belongs to a pre-authorization text attribute set:
determining whether current power of the electronic device is lower than a preset threshold if no text attribute of the text content is detected to belong to the pre-authorized text attribute set;
wherein the driving the electronic ink display screen of the electronic device to display the text content at the first display area comprises:
driving the electronic ink display screen of the electronic device to display the text content at the first display area if the current power is lower than the preset threshold.

18. The electronic device of claim 15, wherein the driving the electronic ink display screen of the electronic device to display the text content at the first display area, and driving the transparent display screen of the electronic device to display the remaining content of the screen contents other than the text content at the second display area comprises:
transmitting content data of the text content to a driving unit of the electronic ink display screen, such that the driving unit of the electronic ink display screen drives the electronic ink display screen to display the text content at the first display area corresponding to the content data of the text content;
setting pixel color data of the text content as black pixel data by changing content data of the screen contents, wherein the black pixel data corresponds to the transparent display state of the transparent display screen;
transmitting content data of the screen contents, which have been changed, to a driving unit of the transparent display screen, such that the driving unit of the transparent display screen drives the transparent display screen to display the screen contents, which have been changed.

19. The electronic device of claim 15, wherein the driving the electronic ink display screen of the electronic device to display the text content at the first display area, and driving the transparent display screen of the electronic device is driven to display the remaining content of the screen contents other than the text content at the second display area comprises:
transmitting content data of the text content to a driving unit of the electronic ink display screen, thus that the driving unit of the electronic ink display screen drives the electronic ink display screen to display the text content at the first display area corresponding to the content data of the text content;
deleting the content data of the text content from content data of the screen contents to obtain content data of the remaining content;
transmitting the content data of the remaining content of the screen contents other than the text content to a driving unit of the transparent display screen, thus that the driving unit of the transparent display screen drives the transparent display screen to display the remaining content of the screen contents other than the text content at the second display area corresponding to the content data of the remaining content.

20. The electronic device of claim 15, wherein the driving the electronic ink display screen of the electronic device to display the text content at the first display area, and driving the transparent display screen of the electronic device is driven to display the remaining content of the screen contents other than the text content at the second display area comprises:
receiving an adjusting operation at the first display area input by a user;
adjusting the first display area of the electronic ink display screen according to the adjusting operation, and adjusting the second display area of the transparent display screen according to an adjustment of the first display area of the electronic ink display screen.

21. (canceled)
